(19) United States
(12) Patent Application Publication
(10) Pub. No.: US 2022/0291729 A1
(43) Pub. Date: Sep. 15, 2022

(54) MODIFY CLOCK-BOOST PARAMETERS

(71) Applicant: Hewlett-Packard Development Company, L.P., Spring, TX (US)

(72) Inventors: Fangyong Dai, Spring, TX (US); Peter Siyuan Zhang, Spring, TX (US); Qijun Chen, Spring, TX (US); Asjad Shamim, Spring, TX (US)

(73) Assignee: Hewlett-Packard Development Company, L.P., Spring, TX (US)

(21) Appl. No.: 17/637,576

(22) PCT Filed: Oct. 3, 2019
(86) PCT No.: PCT/US2019/054426

§ 371 Date: Feb. 23, 2022

(51) Int. Cl. G06F 1/20; G06F 1/08; G06F 11/30

(52) U.S. Cl. CPC G06F 1/206; G06F 1/08; G06F 11/3062

(57) ABSTRACT

Example implementations relate to modifying clock-boost parameters. In some examples, a controller of a computing device may determine a thermal headroom based on a thermal capacity of the computing device, an energy inflow to a processor received from circuitry of the computing device, a temperature of the processor, and a speed of a fan of the computing device, and modify a clock boost parameter for the processor based on the thermal headroom.

### BACKGROUND

Computing devices can include a processor. The processor can have a clock speed which can be indicative of the processor's speed in performing computing device operations. For example, a processor with a higher clock speed may perform a computing device operation faster than a processor with a lower clock speed.

### BRIEF DESCRIPTION OF THE DRAWINGS

FIG. 1 illustrates an example of a computing device to modify clock-boost parameters consistent with the disclosure.

FIG. 2 illustrates an example of an energy flow of a computing device to modify clock-boost parameters consistent with the disclosure.

FIG. 3 illustrates an example of a computing device to modify clock-boost parameters consistent with the disclosure.

FIG. 4 illustrates a block diagram of an example system to modify clock-boost parameters consistent with the disclosure.

### DETAILED DESCRIPTION

A computing device may include a processor having a particular clock speed which includes clock-boost capabilities. As used herein, the term “computing device” can be, for example, a laptop computer, a notebook computer, a desktop computer, and/or a mobile device (e.g., a smart phone, tablet, personal digital assistant, smart glasses, a wrist-worn device, etc.), among other types of computing devices. As used herein, a mobile device can include devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices. As used herein, the term “clock speed” refers to a frequency at which a clock circuit of a processor can generate pulses. As used herein, the term “clock-boost” refers to an increase of a clock speed of a processor from a base clock speed to an intermediate clock speed. For example, a processor may increase its clock speed to an intermediate clock speed for a particular amount of time. Increasing the clock speed of the processor can increase the frequency at which the clock circuit of the processor can generate pulses.

A clock-boost can temporarily increase performance of the processor. However, as a result of the clock-boost, the processor can generate increased heat as a result of an increase in power consumption and/or an increase in fan noise in order to cool the processor. Therefore, a processor may include fixed values for a clock-boost speed and/or duration. Fixed values for the clock-boost speed and/or duration can prevent excess noise, which may exceed regulatory rules, and/or prevent excess heat, which may damage the processor.

The fixed values for the clock-boost may be defined by thermal headroom. As used herein, the term “thermal headroom” refers to a difference between a maximum amount of energy a component can facilitate and a current amount of energy the component is facilitating. The current amount of energy may be defined by a relationship between an amount of power being supplied to the component and generated heat being removed from the component. For example, the values for the clock-boost may be fixed to ensure a conservative amount of thermal headroom in order to ensure the processor is not damaged if a cooling system is not able to remove energy (e.g., generated heat) from the processor at a sufficient rate during a clock-boost event.

As described above, defining fixed values for a clock-boost can prevent damage to a component (e.g., a processor) during a clock-boost event. However, fixed clock-boost values may not maximize clock-boost efficiency. For example, in an instance in which there is excess thermal headroom during a clock-boost event, the processor may have the ability to perform at a higher clock speed without causing damage to the processor than the fixed clock-boost values allow.

Modify clock-boost parameters according to the disclosure can allow for clock-boost parameters to be dynamically modified based on various parameters. The processor can accordingly utilize the dynamic clock-boost parameters during a clock-boost event in order to operate at higher clock speeds for longer durations, which can allow for an overall performance improvement.

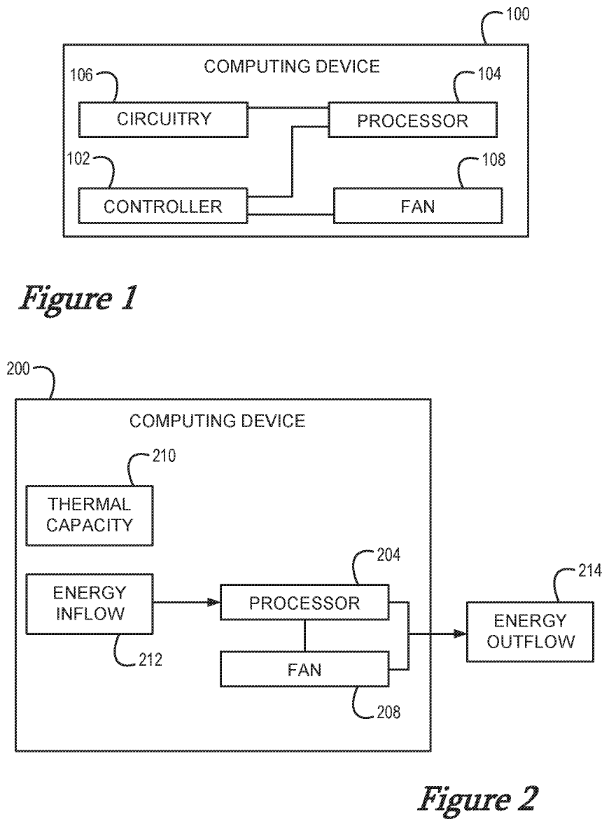

FIG. 1 illustrates an example of a computing device 100 to modify clock-boost parameters consistent with the disclosure. As illustrated in FIG. 1, the computing device 100 can include a controller 102, a processor 104, circuitry 106, and a fan 108.

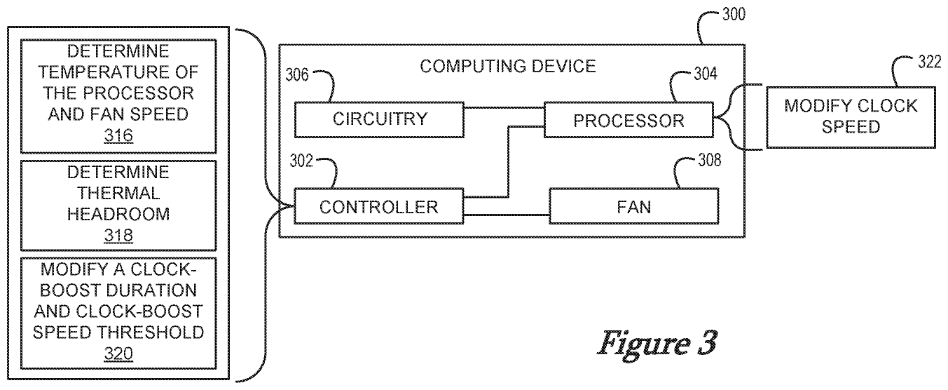

The computing device 100 can be utilized to modify clock-boost parameters. For example, the controller 102 can determine a thermal headroom of the computing device 100 and modify a clock-boost parameter based on the determined thermal headroom, as is further described herein and in connection with FIGS. 2 and 3. The processor 104 can then utilize the modified clock-boost parameters during a clock-boost event, as is further described in connection with FIG. 3.

The computing device 100 can include a fan 108. As used herein, the term “fan” refers to a device to create a flow in a fluid. For example, the fan 108 can create a flow of gas (e.g., air) in and/or around computing device 100. The fan 108 can be utilized to, for example, cool the processor 104, as is further described in connection with FIGS. 2 and 3.

The computing device 100 can include circuitry 106. As used herein, the term “circuitry” refers to a collection of electronic components connected by wires or traces through which electric current can flow. For example, the circuitry 106 can include a collection of resistors, transistors, capacitors, inductors, diodes, etc. which can be connected by wires or traces such that electric current can flow through the electronic components. The circuitry 106 can be, for example, an integrated circuit, ARM processor, logic, application-specific integrated circuit (ASIC), system on a chip (SoC), programmable-gain amplifier (PGA), among other types of circuitry.

The circuitry 106 can determine an energy inflow to the processor 104, As used herein, the term “energy inflow” refers to an amount of power being supplied to a component. For example, a power input such as a power supply can provide energy (e.g., power) to the processor 104 of the computing device 100. The circuitry 106 can determine the power supply is supplying 60 Watts/second to the processor 104, among other examples.

The computing device 100 can include a controller 102. The controller 102 can determine a temperature of the processor 104. For example, the controller 102 can determine the processor 104 is operating at 50° C., among other examples. In some examples, the controller 102 can utilize a platform environment control interface (PECI) bus to determine the temperature of the processor 104, However, examples of the disclosure are not so limited to a PECI bus, For instance, the controller 102 can utilize any other type of mechanism to determine the temperature of the processor 104.

The controller 102 can determine a fan speed of the fan 108. For example, the controller 102 can determine the fan 108 is operating at 2000 rotations per minute (RPM).

The controller 102 can determine a thermal headroom of the computing device 100 based on the thermal capacity of the computing device 100, the amount of power to the processor 104, the temperature of the processor 104, and the speed of the fan 108. For example, the controller 102 can determine a difference between a maximum amount of energy the computing device 100 can facilitate and a current amount of energy the computing device 100 is facilitating, as is further described in connection with FIG. 2.

The controller 102 can modify a clock-boost parameter for the processor 104 based on the determined thermal headroom, As described above, a clock-boost of the processor 104 can refer to an increase in the clock speed of the processor 104. The clock speed of the processor 104 can be increased according to a clock-boost parameter.

In some examples, the clock-boost parameter can be a clock-boost speed threshold. As used herein, the term “clock-boost speed threshold” refers to an intermediate threshold clock speed of a processor, For example, the clock-boost speed threshold can be a clock speed determined by the controller 102 that is greater than a base clock speed (e.g., 2 Gigahertz (GHz)) but less than or equal to a maximum allowable clock speed (e.g., 5 GHz), among other examples of base and maximum allowable clock speeds.

In some examples, the clock-boost parameter can be a clock-boost duration. As used herein, the term “clock-boost duration” refers to an amount of time the clock speed of the processor is raised from a base clock speed to a clock-boost speed threshold. For example, the clock-boost duration can be an amount of time the processor 104 is at the clock-boost speed threshold.

As described above, the controller 102 can determine the clock-boost parameters utilizing the thermal capacity of the computing device 100, an energy inflow to the processor 104, the temperature of the processor 104, and the speed of the fan 108. The energy inflow to the processor 104 can be an amount of power to the processor 104, and the thermal capacity of the computing device 100 can be a fixed value, as is further described in connection with FIG. 2.

FIG. 2 illustrates an example of an energy flow of a computing device 200 to modify clock-boost parameters consistent with the disclosure. As illustrated in FIG. 2, the computing device 200 can include a processor 204, a fan 208, a thermal capacity 210, an energy inflow 212, and an energy outflow 214.

As illustrated in FIG. 2, the computing device 200 can include a thermal capacity 210. As used herein, the term “thermal capacity” refers to a characteristic of the computing device that describes an amount of energy to heat components of the computing device to a predetermined temperature without temperature mitigation. For example, the thermal capacity 210 of computing device 200 can be described by an amount of energy to heat components (e.g., the processor 204, a heat sink associated with the processor, etc.) of the computing device 200 to a particular temperature without thermal energy being emitted from the computing device 200 (e.g., via the fan 208 or other heat transfer mechanisms). The thermal capacity can be a predetermined value that is computing device dependent. For example, a first computing device may have a first thickness (e.g., 50 millimeters (mm)) and include a particular heatsink such that the amount if energy to heat the components of the first computing device to a predetermined temperature (e.g., 100° C.) is greater than a second computing device having a second thickness (e.g., 30 mm) and a same or different heatsink. In other words, the thermal capacity 210 of any given computing device 200 can depend on how much energy it can take to heat components of the computing device to a predetermined temperature. The thermal capacity 210 can depend on a type and/or size of heatsink, the dimensions of the computing device, among other thermal variables.

Although the predetermined temperature is described above as being 100° C., examples of the disclosure are not so limited. For example, the predetermined temperature can be greater than or less than 100° C.

The computing device 200 can include an energy inflow 212 to the processor 204. As previously described in connection with FIG. 1, the energy inflow 212 to the processor 204 can be an amount of power being supplied to the processor 204. For example, a power supply of the computing device 200 can supply power to the processor 204, and circuitry (e.g., not illustrated in FIG. 2) of the computing device 200 can determine the amount of power being supplied to the processor 204.

The computing device 200 can include an energy outflow 214. As used herein, the term “energy outflow” refers to an amount of energy being evacuated from a component. For example, power supplied to the processor 204 can generate thermal energy (e.g., heat). The fan 208 and/or a heat sink associated with the processor 204 (e.g., not illustrated in FIG. 2) can cause an amount of energy to be evacuated (e.g., the energy outflow 214) from the computing device 200. In addition to the fan 208 and/or the heat sink, the physical dimensions and/or material properties of the computing device 200, among other thermal characteristics may drive the energy outflow 214 from the computing device 200.

As previously described in connection with FIG. 1, a controller (e.g., not illustrated in FIG. 2) can determine a thermal headroom of the computing device 200. The controller can determine the thermal headroom based on the thermal capacity 210 of the computing device 200, the amount of power (e.g., energy inflow 212) supplied to the processor 204, the temperature of the processor 204, and a speed of the fan 208 (e.g., which can drive energy outflow 214). The thermal headroom can be a relationship between the energy inflow 212 to the processor 204, the energy outflow 214, and a maximum amount of energy the computing device 200 can facilitate.

An indicium of the thermal headroom can be temperature. For example, a maximum amount of energy the computing device 200 can facilitate may be indicated as a temperature of 100° C. according to the thermal capacity 210 of the computing device 200 and a current amount of energy the computing device 200 is facilitating (e.g., energy inflow 212 and energy outflow 214) may be indicated as a temperature of 50° C. Accordingly, the thermal headroom of the computing device 200 at the particular moment the computing device 200 includes the amount of energy indicated by the temperature of 50° C. can be the difference between the maximum amount of energy (e.g., indicated as a temperature of 100° C.) and the current amount of energy the computing device 200 is facilitating (e.g., indicated as a temperature of 50° C.). The controller of the computing device 200 may modify clock-boost parameters based on the determined thermal headroom, as is further described in connection with FIG. 3.

FIG. 3 illustrates an example of a computing device 300 to modify clock-boost parameters consistent with the disclosure. As illustrated in FIG. 3, the computing device 300 can include a controller 302, a processor 304, circuitry 306, and a fan 308.

As previously described in connection with FIG. 1, the computing device 300 can be utilized to modify clock-boost parameters. For example, the controller 302 can determine a thermal headroom of the computing device 300 and modify a clock-boost parameter based on the determined thermal headroom, as is further described herein.

The circuitry 306 can determine an amount of power supplied to the processor 304 from a power input. For example, a power input such as a power supply can provide power to the processor 304 of the computing device 300. The circuitry 306 can determine the power supply is supplying 60 Watts/second to the processor 304, among other examples.

The computing device 300 can include a processor 304, circuitry 306, and a fan 308. The processor 304 of the computing device 300 may be a central processing unit (CPU), a semiconductor-based microprocessor, and/or other hardware devices suitable for retrieval and execution of non-transitory machine-readable instructions stored in a memory resource (not illustrated in FIG. 3). The processor 304 may fetch, decode, and execute the stored instructions to perform actions related to computing operations. As an alternative or in addition to retrieving and executing the stored instructions, the processor 304 may include a plurality of electronic circuits that include electronic components for performing the functionality of the stored instructions to perform actions related to computing operations.

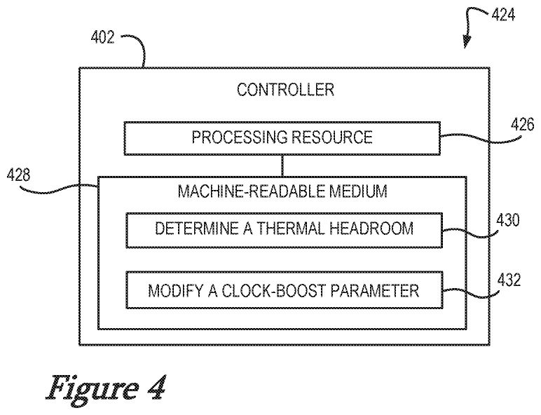

The controller 302 may include a processing resource for retrieval and execution of non-transitory machine-readable instructions stored in a memory resource (not illustrated in FIG. 3). For example, the processing resource may fetch, decode, and execute stored instructions to perform actions related to modifying clock-boost parameters, as is further described in connection with FIG. 4.

The memory resource may be any electronic, magnetic, optical, or other physical storage device that stores the non-transitory machine-readable executable instructions and/or data. Thus, memory resource may be, for example, Random Access Memory (RAM), an Electrically-Erasable Programmable Read-Only Memory (EEPROM), a storage drive, an optical disc, and the like. The memory resource may be disposed within the computing device 300. Additionally, the memory resource may be a portable, external or remote storage medium, for example, that causes the computing device 300 to download the instructions from the portable/external/remote storage medium.

The controller 302 can, at 316, determine a temperature of the processor 304 and a speed of the fan 308. For example, the controller 302 can determine the processor 304 is operating at 50° C., among other examples of processor temperatures. Further, the controller 302 can determine the fan 308 is operating at 2000 RPM, among other examples of fan speeds.

The controller 302 can, at 318, determine a thermal headroom of the computing device 300. For example, the controller 302 can determine the thermal headroom based on the thermal capacity of the computing device 300, the amount of power supplied to the processor 304, the temperature of the processor 304, and the speed of the fan 308. As previously described in connection with FIG. 2, the thermal capacity of the computing device 300 can be a predetermined value. For example, the controller 302 can determine the thermal headroom of the computing device 300 at the particular moment the computing device 300 includes an amount of energy the computing device 300 is facilitating indicated by the temperature of 50° C., which can be the difference between the maximum amount of energy (e.g., indicated as a temperature of 100° C.) and the current amount of energy the computing device 300 is facilitating (e.g., indicated as a temperature of 50° C.).

The controller 302 can, at 320, modify a clock-boost parameter based on the thermal headroom. For example, based on the thermal headroom (e.g., the difference between the maximum amount of energy indicated as a temperature of 100° C. and the current amount of energy the computing device 300 is facilitating indicated as a temperature of 50° C.), the controller 302 can modify a clock-boost duration and/or a clock-boost speed threshold for the processor 304. For example, the clock-boost duration may be one minute, and based on the thermal headroom, the controller 302 can modify the clock-boost parameter to be two minutes. As another example, the clock-boost speed threshold may be 4 GHz, and based on the thermal headroom, the controller 302 can modify the clock-boost speed threshold to 4.5 GHz. Further, the controller 302 can modify both the clock-boost duration and clock-boost speed threshold (e.g., from 2 GHz for one minute to 4.5 GHz for two minutes), among other examples.

The controller 302 can determine the thermal headroom and modify the clock-boost parameter(s) according to predetermined time intervals, For example, the controller 302 can, at 318, determine thermal headroom and, at 320, modify the clock-boost duration and/or a clock-boost speed threshold every one second, every five seconds, every minute, etc. Further, the predetermined time interval may be modifiable.

The processor 304, at 322, can utilize the clock-boost parameter during a clock-boost event in response to a clock-boost event occurring. As used herein, the term “clock-boost event” refers to an occurrence in which a processor modifies its clock speed. For example, the processor 304 can utilize a clock-boost parameter during an occurrence in which the processor 304 increases its clock speed from a base clock speed to the clock-boost speed threshold. For instance, the processor 304 can modify its clock speed from a base clock speed (e.g., 2 GHz) to a clock-boost speed threshold (e.g., 4 GHz) for a clock-boost duration (e.g., 1 minute), among other examples.

The controller 302 can determine when a clock-boost event occurs. For example, the controller 302 can determine that, in response to an energy inflow to the processor 304 increasing to exceed a threshold amount of change, that a clock-boost event is occurring. For instance, utilizing the circuitry 306, the controller 302 can determine that an amount of power supplied to the processor 304 can be 60 Watts/second. In response to the controller 302 determining the amount of power supplied to the processor 304 increased to 90 Watts/second (e.g., exceeding a threshold amount of change of 20 Watts/second), the controller 302 can determine that a clock-boost event is occurring. Accordingly, the controller 302 can determine an updated amount of power supplied to the processor 304 (e.g., 90 Watts/second).

In some examples, the controller 302 can adjust the fan speed of the fan 308 to an updated fan speed in response to the clock-boost event occurring. For example, the fan speed of the fan 308 prior to the clock-boost event occurring may be 2000 RPM. The controller 302 can adjust (e.g., increase) the fan speed to an updated fan speed of 4000 RPM in response to the clock-boost event occurring.

Although the controller 302 is described as increasing the fan speed of the fan 308 to 4000 RPM, examples of the disclosure are not so limited. For example, the controller 302 can increase the fan speed of the fan 308 to a maximum allowable fan speed, which may be based on an acoustic policy dictated by regulatory standards, among other examples.

Based on the updated fan speed of the fan 308 to 4000 RPM, the controller 302 can determine an updated thermal headroom. For example, during the clock-boost event the amount of power supplied to the processor 304 can be increased. The controller 302 can determine an updated temperature of the processor 304 (e.g., an increased temperature due to the increase in power supplied to the processor 304) and the updated fan speed of the fan 308 (e.g., 4000 RPM) during the clock-boost event.

The controller 302 can determine an updated thermal headroom of the computing device 300 based on the updated temperature of the processor 304, the updated fan speed of the fan 308, and the updated amount of power supplied to the processor 304 via the circuitry 306 (e.g., determined when the energy inflow to the processor increases to exceed the threshold amount of change of power signaling the clock-boost event is occurring).

The controller 302 can update the modified clock-boost parameter during the clock-boost event in response to an input. Utilizing the updated thermal headroom, the controller 302 can revise the clock-boost speed threshold from 4 GHz to 5 GHz (e.g., in an example in which additional thermal headroom exists, for example, as a result of the updated fan speed of fan 308), and/or modify the clock-boost duration (e.g., from 1 minute to 2 minutes at 4 GHz or 5 GHz).

The processor 304 can utilize the updated clock-boost parameter (e,g., the revised clock-boost speed threshold and/or the modified clock-boost duration) for a remaining duration of the clock-boost event. In some examples, if the clock-boost duration is 1 minute and the clock-boost speed threshold is 4 GHz, and the revised clock-boost speed threshold is determined 30 seconds in to the clock-boost duration to be 5 GHz and the clock-boost duration remains unchanged as a result of the fan speed increase, the processor 304 can utilize the revised clock-boost speed threshold of 5 GHz for the remaining 30 seconds of the clock-boost duration. In some examples, if the clock-boost duration is 1 minute and the clock-boost speed threshold is 4 GHz, and the revised clock-boost speed threshold is determined 30 seconds in to the clock-boost duration to be 5 GHz and the clock-boost duration is modified to be 2 minutes as a result of the fan speed increase, the processor 304 can utilize the updated clock-boost parameter (e.g., a revised clock-boost speed threshold of 5 GHz) for the remaining duration of the clock-boost event (e.g., 1 minute 30 seconds).

The controller 302 can update the updated clock-boost parameter for the processor 304 during the clock-boost event to cause the fan speed of the fan 308 to be updated in response to an input. The input can be, for example, a user input, For instance, a user may decide an increase in performance is desired during a clock-boost event and can provide a user input to allow the fan speed of the fan 308 to be updated during a clock-boost event.

The controller 302 can determine when a clock-boost event has ceased. For example, the controller 302 can determine that, in response to the circuitry 306 determining the amount of power to the processor 304 has been reduced beyond a threshold amount of change, that a clock-boost event has ceased. For instance, an amount of power to the processor 304 can be 90 Watts/second and, in response to the power to the processor 304 decreasing to 60 Watts/second (e.g., reducing beyond a threshold amount of change of 20 Watts/second), the controller 302 can determine that a clock-boost event has ceased.

The processor 304 can modify its clock speed from the clock-boost speed threshold to the base clock speed in response to the clock-boost duration expiring. For example, the clock-boost parameters may indicate the clock-boost speed threshold is 4 GHz for a clock-boost duration of 1 minute. After the 1 minute has expired, the processor 304 can modify its clock speed from the clock speed threshold (e.g., 4 GHz) to the base clock speed (e.g., 2 GHz).

Modify clock-boost parameters according to the disclosure can allow for continuous and/or dynamic modification of clock-boost parameters based on the thermal headroom of the computing device at the time the clock-boost parameters are determined. When a clock-boost event occurs, the processor can utilize the current clock-boost parameters. The processor can accordingly operate at higher clock speeds for longer durations, which can allow for an overall performance improvement.

FIG. 4 illustrates a block diagram of an example system 424 to modify clock-boost parameters consistent with the disclosure. In the example of FIG. 4, system 424 includes a processing resource 426 and a machine-readable storage medium 428. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 426 may be a central processing unit (CPU), microprocessor, and/or other hardware device suitable for retrieval and execution of instructions stored in machine-readable storage medium 428. In the particular example shown in FIG. 4, processing resource 426 may receive, determine, and send instructions 430 and 432. As an alternative or in addition to retrieving and executing instructions, processing resource 426 may include an electronic circuit comprising a number of electronic components for performing the operations of the instructions in machine-readable storage medium 428. With respect to the executable instruction representations or boxes described and shown herein, it should be understood that part or all of the executable instructions and/or electronic circuits included within one box may be included in a different box shown in the figures or in a different box not shown.

Machine-readable storage medium 428 may be any electronic, magnetic, optical, or other physical storage device that stores executable instructions. Thus, machine-readable storage medium 428 may be, for example, Random Access Memory (RAM), an Electrically-Erasable Programmable Read-Only Memory (EEPROM), a storage drive, an optical disc, and the like. The executable instructions may be “installed” on the system 424 illustrated in FIG. 4. Machine-readable storage medium 428 may be a portable, external or remote storage medium, for example, that allows the system 424 to download the instructions from the portable/external/remote storage medium. In this situation, the executable instructions may be part of an “installation package”. As described herein, machine-readable storage medium 428 may be encoded with executable instructions associated with modifying clock-boost parameters.

Determine instructions 430, when executed by a processor such as processing resource 426, may cause system 424 to determine a thermal headroom of a computing device. For example, the processing resource 426 may determine a thermal headroom of the computing device based on a thermal capacity of the computing device, an energy inflow to a processor of the computing device, a temperature of the processor, and a speed of the fan. The thermal capacity of the computing device can be a predetermined value that can be described by an amount of energy to heat up components of the computing device, such as the processor, a heat sink associated with the processor, etc., to a particular temperature without thermal energy being emitted from the computing device (e.g., via a fan or other heat transfer mechanisms). The energy inflow can be an amount of power supplied to the processor from a power supply of the computing device.

Modify instructions 432, when executed by a processor such as processing resource 426, may cause system 424 to modify a clock-boost parameter for the processor based on the thermal headroom. A clock-boost parameter can include, for instance, a clock-boost duration and/or a clock-boost speed threshold. For example, the system 424 can modify a clock-boost speed threshold (e.g., 4 GHz) and/or a clock-boost duration (e.g., 1 minute) for a clock-boost event. The processor of the computing device can accordingly utilize the clock-boost parameter(s) during a clock-boost event to allow the processor to operate at higher clock speeds for longer durations, which can allow for a performance improvement of the processor.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 104 may reference element “04” in FIG. 1, and a similar element may be referenced as 204 in FIG. 2.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, “a plurality of” an element and/or feature can refer to more than one of such elements and/or features.

What is claimed:

1. A non-transitory machine-readable medium including instructions that when executed cause a controller of a computing device to:
determine a thermal headroom based on:
a thermal capacity of the computing device;
an energy inflow to a processor received from circuitry of the computing device;
a temperature of the processor; and
a speed of a fan of the computing device; and
modify a clock-boost parameter for the processor based on the thermal headroom.

2. The non-transitory machine-readable medium of claim 1, wherein the clock-boost parameter includes a clock-boost speed threshold.

3. The non-transitory machine-readable medium of claim 1, wherein the clock-boost parameter includes a clock-boost duration.

4. The non-transitory machine-readable medium of claim 1, further including instructions that when executed cause the controller to determine the thermal headroom and modify the clock-boost parameter according to predetermined time intervals.

5. A computing device, comprising:
a processor;
a fan;
circuitry to determine an amount of power from a power input to the processor; and
a controller, wherein the controller is to:
determine a temperature of the processor and a fan speed of the fan;
determine a thermal headroom based on a thermal capacity of the computing device, the amount of power to the processor, the temperature of the processor, and the fan speed; and
modify a clock-boost parameter for the processor based on the thermal headroom.

6. The computing device of claim 5, wherein the processor is to utilize the clock-boost parameter during a clock-boost event.

7. The computing device of claim 5, wherein the controller is to determine a clock-boost event has ceased in response to the circuitry determining the amount of power to the processor is reduced beyond a threshold amount

8. The computing device of claim 5, wherein the controller is to update the modified clock-boost parameter to an updated clock-boost parameter for the processor during a clock-boost event in response to an input.

9. The computing device of claim 8, wherein the processor is to utilize the updated clock-boost parameter for a remaining duration of the clock-boost event.

10. A computing device, comprising:
a processor;
a fan;
circuitry to determine an amount of power supplied to the processor;
a controller, wherein the controller is to:
determine a temperature of the processor and a fan speed of the fan of the computing device;
determine a thermal headroom based on a thermal capacity of the computing device, the amount of power supplied to the processor, the temperature of the processor, and the fan speed; and
modify a clock-boost duration and a clock-boost speed threshold for the processor based on the thermal headroom;
wherein the processor is to modify a clock speed of the processor from a base clock speed to the clock-boost speed threshold for the clock-boost duration in response to a clock-boost event occurring.

11. The computing device of claim 10, wherein the controller is to adjust he fan speed to an updated fan speed in response to the clock-boost event occurring.

12. The computing device of claim 11, wherein in response to the controller adjusting the fan speed, the controller is to:
determine an updated temperature of the processor and the updated fan speed of the fan during the clock-boost event; and
determine an updated thermal headroom based on the updated temperature of the processor, the updated fan speed, and an updated amount of power supplied to the processor via the circuitry.

13. The computing device of claim 12, wherein the processor is to modify from a group consisting of:
the clock-boost duration; and
the clock speed of the processor from the clock-boost speed threshold to a revised clock-boost speed threshold based on the updated thermal headroom.

14. The computing device of claim 13, wherein the processor is to modify the clock speed of the processor to the revised clock-boost speed threshold for a remaining duration of the clock-boost event.

15. The computing device of claim 10, wherein the processor is to modify its clock speed from the clock-boost speed threshold to the base clock speed in response to the clock-boost duration expiring.
